(19) United States
(12) Patent Application Publication
(10) Pub. No.: US 2011/0014357 A1
(43) Pub. Date: Jan. 20, 2011

(54) Insulative Paste and Method for Manufacturing Organic Light Emitting Device Using the Same

(76) Inventors: Hyuk LIM, Seoul (KR); Hyung Sup Lee, Suwon-si (KR); Young Sam Yu, Seoul (KR)

Correspondence Address: THE LAW OFFICES OF ANDREW D. FORTNEY, PH.D., P.C., 215 W FALLBROOK AVE SUITE 203, FRESNO, CA, 93711, US

(21) Appl. No.: 12/832,355

(22) Filed: Jul. 8, 2010

(30) Foreign Application Priority Data
Jul. 15, 2009 (KR) 10-2009-0064483

(51) Int. Cl. B05D 5/12; C09D 11/02

(52) U.S. Cl. 427/77; 106/31.13

(57) ABSTRACT

An insulative paste and a method for manufacturing an organic light emitting device using the same are provided. The insulative paste is adapted to form an insulating layer in an electro-optical device by printing, and includes: a liquid phase organic insulating material having a viscosity; and a solid particle included in the liquid phase organic insulating material, wherein the solid particle has a positive curvature with respect to a horizontal plane of the insulating layer. Thus, by adding the solid particle to the liquid phase organic insulating material to prepare the insulative paste and patterning the insulating paste, a fine insulating layer pattern can be formed.

### CROSS-REFERENCE TO RELATED APPLICATION

This application claims priority to Korean Patent Application No. 10-2009-0064483 filed on Jul. 15, 2009 and all the benefits accruing therefrom under 35 U.S.C. §119, the contents of which are incorporated by reference in their entirety.

### BACKGROUND

The present invention relates to an insulative paste and a method for manufacturing an organic light emitting device using the same, and more particularly, to an insulative paste, that is, an insulative ink used for forming an organic insulating layer in a flat panel display such as an organic light emitting device.

A liquid crystal display (LCD), a plasma display panel (PDP), an organic light emitting diode (OLED) and the like are used as a flat panel display.

The flat panel display usually has electric devices and electric interconnection lines formed therein. Therefore, an insulating layer is required for insulation between the electric devices and the electric interconnection lines. In recent years, as the size of the device and spacing between the interconnection lines are decreased, the insulating layer for insulating the devices and interconnection lines are required to be formed in a fine pattern.

In a related art, an organic insulating layer is being used in order to form the insulating layer in a fine pattern. For example, insulative organic material such as photoresist (PR) is used as the organic insulating layer. That is, the organic insulating layer such as PR is coated on a substrate and then exposure and development process is performed to form a fine insulating pattern.

However, the processes in accordance with the related art are accompanied by a photolithography process, so that manufacturing process gets complicated and cost for manufacturing equipment is increased. Due to these drawbacks, the unit price for production and process time for manufacturing are increased to deteriorate the production yield.

In the above circumstances, printing techniques (e.g., screen printing, offset, gravure printing, inkjet printing) have been recently proposed as a method of patterning a fine insulating layer without using the photolithography process.

According to the printing techniques, a paste (i.e., ink) is coated to form an organic layer having a fine pattern and the organic layer is cured through light or heat to form an insulating layer having a fine pattern. However, in the printing techniques of the related art, the paste (i.e., ink) has a liquid (or gel) state having the fluidity. That is, the paste has a liquid state the viscosity of which is equal to or less than 10000 CPS. Therefore, reflow of the paste occurs during coating (i.e., patterning) and before curing of the paste, so that a layer pattern may spread exceeding an intended line width.

### SUMMARY

The present disclosure provides an insulative paste which is configured to include an insulative organic material with a viscosity, the insulative organic material having fine solid particles with a constant curvature added thereto, and can prevent reflow of the paste to form a fine insulative pattern, and a method for manufacturing an organic light emitting device using the same.

In accordance with an exemplary embodiment, there is provided an insulative paste which is used for manufacturing an insulating layer for insulating an electro-optical device through a printing process. The insulative paste may include: a liquid phase organic insulating material having a viscosity; and a solid particle included in the liquid phase organic insulating material, wherein the solid particle has a positive curvature with respect to a horizontal plane on the insulating layer.

The insulative paste may include 30 wt % to 85 wt % solid particle and 15 wt % to 70 wt % insulative organic material.

In accordance with another exemplary embodiment, there is provided an insulative paste used for manufacturing an insulating layer for insulating an electro-optical device through a printing method. The insulative paste may include: a 30 wt % to 85 wt % solid particle; and a 15 wt % to 70 wt % liquid phase organic insulating material.

The solid particle may have a maximum diameter ranging from 10 nm to 15 μm. The solid particle may have a circular section, an elliptical section, or a polygonal section. The solid particle may have a concave groove formed on a surface thereof.

In accordance with yet another exemplary embodiment, a method for manufacturing an organic light emitting device, the method includes: forming a transparent electrode on a substrate; printing an insulative paste including an insulative organic material and a solid particle on at least an edge region of the transparent electrode; curing the insulative paste to form an insulating layer; and forming an organic light emitting layer on the transparent electrode exposed by the insulating layer.

The printing of the insulative paste may include: preparing an insulative paste by mixing the insulative organic material and the solid particle; and printing the insulative paste on the substrate through a printing method.

The solid particle may have a positive curvature with respect to a horizontal plane on the insulating layer and have a maximum diameter ranging from 10 nm to 15 μm.

The solid particle may have a circular section, an elliptical section, or a polygonal section.

### BRIEF DESCRIPTION OF THE DRAWINGS

Exemplary embodiments can be understood in more detail from the following description taken in conjunction with the accompanying drawings, in which:

FIGS. 1 through 3 are schematic sectional views for illustrating a method for manufacturing an organic light emitting device in accordance with an exemplary embodiment;

FIG. 4 is a schematic view for illustrating characteristics of an insulative paste material;

FIG. 5 is a flowchart for illustrating a method for forming an insulating layer.

### DETAILED DESCRIPTION OF EXEMPLARY EMBODIMENTS

Hereinafter, exemplary embodiments of the present invention will be described below in more detail with reference to the accompanying drawings. The present invention may, however, be embodied in different forms and should not be construed as limited to the exemplary embodiments set forth herein. Rather, these exemplary embodiments are provided so that this disclosure will be thorough and complete, and will fully convey the scope of the present invention to those skilled in the art. Like reference numerals refer to like elements throughout.

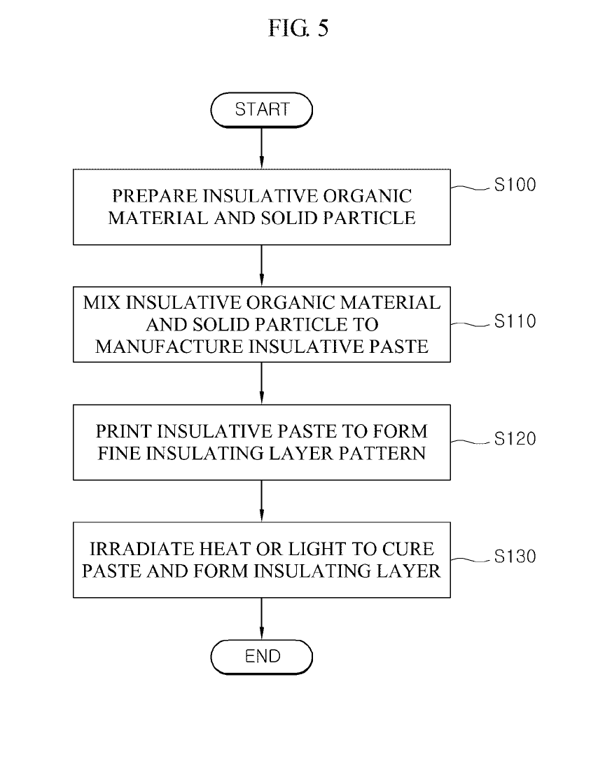

FIGS. 1 through 3 are schematic sectional views for illustrating a method for manufacturing an organic light emitting device in accordance with an exemplary embodiment. FIG. 4 is a schematic view for illustrating characteristics of an insulative paste material. FIG. 5 is a flowchart for illustrating a method for forming an insulating layer.

Referring to FIG. 1, a lower transparent electrode 110 is formed on a substrate 100.

The substrate 100 may be a glass substrate or a plastic substrate, but not limited thereto. A thin silicon substrate or a sapphire substrate may be used as the substrate 100. In this exemplary embodiment, a transparent glass substrate is used as the substrate 100.

Next, a transparent conductive layer is formed on the substrate 100 through a sputtering process. The transparent conductive layer may be formed through one of various deposition processes as well as the sputtering process. Herein, the transparent conductive layer is a thin conductive layer having a 50% or more light transmittance. The transparent conductive layer may be formed of any one of ITO, IZO, ZnO, SnO and In₂O₃. In this exemplary embodiment, an ITO layer is used as the transparent conductive layer. That is, the transparent conductive layer is formed by forming an ITO layer on the glass substrate through a sputtering process.

Thereafter, a photoresist is coated on the transparent conductive layer and is patterned to form a lower transparent electrode 110 having a fine pattern (with a line width of about 1 μm to about 30 μm) through an exposure and development process (i.e., photolithography process).

Of course, this exemplary embodiment is not limited thereto. For example, the lower transparent electrode 110 may be formed by coating a transparent conductive layer and performing a scribing process. The scribing process may be a laser scribing process. Through the laser scribing process, the lower transparent electrode 110 on an active region (e.g., a region where an electric optical device (e.g., OLED) is formed) is left and the transparent conductive layer on a non-active region is removed. Herein, the laser scribing is a process to pattern the transparent electrode 110 by irradiating a laser light in one direction. Through the laser scribing, the lower transparent electrode 110 is finely patterned, and the process can be simplified.

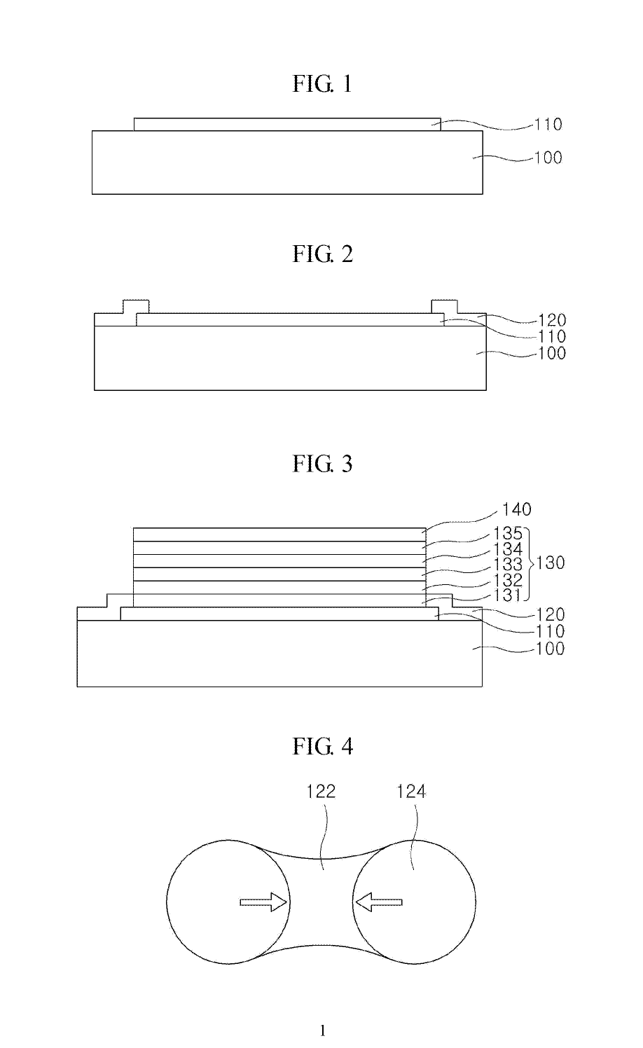

Next, referring to FIG. 2, an insulating layer 120 is formed on exposed regions of the substrate 100 and on edge regions of the patterned lower transparent electrode 110.

The insulating layer 120 is formed through a printing process. That is, the insulating layer 120 is formed by printing an insulative paste (i.e., insulative ink) on the substrate 100 in the form of an intended pattern (i.e., shape) and curing the printed insulative paste by irradiating heat or light. However, as mentioned in the section of the background, the related art insulative paste is an insulative organic material (i.e., liquid phase or gel phase) having the fluidity and viscosity. Therefore, due to reflow phenomenon in the period after the printing before the curing, the width of the insulating layer pattern may be greater than an initially intended pattern width and the insulating layer pattern may have an imperfect shape. Therefore, in this exemplary embodiment, the reflow phenomenon is prevented by using an insulative paste prepared by adding solid particles 124 to the insulative organic material.

In the case of paste including liquid phase only, shape and dimension of a pattern are easily changed after the printing due to the reflow phenomenon.

However, when solid particles 124 having a positive curvature are added as shown in FIG. 4, the positive curvature by the solid particles 124 and a negative curvature by the viscous liquid component (i.e., see 122 of FIG. 4) coexist at the same time. As such, the reflow phenomenon of the viscous liquid component can be suppressed.

In an initial printing stage, the solid component is in a relaxed state in the liquid component and subject to a viscous flow, so that the printing can be easily performed. Directly after the paste is printed on the substrate, the solid component having the positive curvature coexists with the liquid component to have a uniform distribution. The liquid component existing between the adjacent solid components has the negative curvature relative to the solid component, which let the liquid component be subject to compressive stress, so that reflow can be suppressed. As a result, the shape and dimension can remain unchanged during and after the curing process.

Herein, the curvature indicates an effect that liquid between adjacent solids attracts the solids, and, for example, indicates bending or bending degree of a line. Therefore, it may be effective that the solid according to the present exemplary embodiment has a spherical shape other than a polygonal shape. At this time, the positive curvature indicates that at least some of a curved line is bent upwardly with respect to a horizontal plane parallel to an upper surface of the insulating layer 120, and the negative curvature indicates that at least some of a curved line is bent downwardly with respect to a horizontal plane parallel to an upper surface of the insulating layer 120. A particle having the positive curvature may indicate a particle having a convex curvature.

Thus, the insulative paste according to the present exemplary embodiment includes an insulative organic material 122 and solid particles 124. Herein, the insulative organic material 122 is prepared by mixing an insulative polymer material and an organic solvent. At this time, according to the content of the organic solvent, an overall viscosity of the insulative paste is changed. Therefore, in this exemplary embodiment, the liquid insulative organic material 122 is prepared by mixing 30 wt % to 85 wt % organic solvent and 15 wt % to 70 wt % insulative polymer material. In the case where the weight percent of the organic solvent gets out of the upper limit of the range, the viscosity of the paste is weakened and thus a spread problem after the printing is caused, and in the case where the weight percent of the organic solvent gets out of the lower limit of the range, the viscosity of the paste is too strong to make it possible to perform the printing process.

It may be effective that the solid particles 124 used in the insulative paste are spherical fine particles, but of course, the present invention is not limited thereto. For example, the solid particles 124 may be polygonal or elliptical fine particles. That is, it may be effective that the solid particle 124 has a section with a shape of a circle, ellipse or polygon. Of course, the solid particle 125 may be a transparent particle. The solid particle 124 used in this exemplary embodiment has a spherical shape. However, it is also possible that the spherical solid particle 124 has concave grooves formed on a surface thereof. The insulative organic material may be received in the concave grooves to improve the variation in the curvature between solid material and liquid material. It may be effective that the entire surface of the solid particle 124 has a spherical shape (i.e., convex shape with respect to the horizontal plane). In the case where a particle having a negative curvature is used as the solid particle 124, reflow of the insulative paste may occur easily. Therefore, it is preferable that the solid particle 124 having the positive curvature is used in this exemplary embodiment.

At this time, it may be effective that the size of the fine solid particle 124 is smaller than the diameter of a nozzle of a printing apparatus printing the insulative paste. Thus, it may be effective that the diameter of the solid particle 124 is varied with the diameter of the nozzle. Preferably, it may be effective that the maximum diameter of the solid particle 124 is in a range of 10 nm to 15 μm. Herein, when the diameter of the solid particle 124 is larger than the above diameter range, the nozzle is clogged with the solid particle 124, so it is difficult to perform the printing process and the size of the solid particle is larger than a pattern size. When the diameter of the solid particle 124 is less than the above diameter range, a force for preventing reflow, such as a compressive stress, is decreased, so that reflow may be generated.

Herein, the material of the solid particle is not limited to ceramic (SiO₂, Al₂O₃, etc.), plastic and polymer, and may be selected from various kinds of materials. The solid particle may be formed of a material selected from various materials which can be made in a spherical shape, other than a metallic (i.e., conductive) particle.

Also, it may be effective that the insulative paste includes the solid particles 124 and the insulative organic material by a predetermined weight percent. Preferably, the insulative paste may include 30 wt % to 85 wt % solid particles 124 and 15 wt % to 70 wt % insulative organic material 122. When the content of the insulative solid particles 24 is greater than the upper limit, the quality of the layer may be lowered and crack may be generated in the layer during a subsequent process. Also, when the content of the solid particles 124 is less than the lower limit, reflow of the paste may occur.

Thus, in the present exemplary embodiment, the foregoing insulative paste is prepared and is then patterned on the substrate 100 through the printing method to form the insulating layer.

The method for forming the insulating layer will be described with reference to the flowchart of FIG. 5.

First, insulative organic material 122 and solid particles 124 are prepared (S100).

The insulative organic material 122 and the solid particles 124 are stirred and mixed within the above-mentioned range to manufacture an insulative paste (S120).

Next, the manufactured insulative paste is supplied to the printing apparatus. The insulative paste is printed on the substrate 100 through the printing apparatus to form a fine insulating pattern (S130). At this time, the insulating pattern manufactured by using the paste including the solid particles 124 does not cause reflow phenomenon. Therefore, the insulating pattern can maintain an initial patterned shape. Accordingly, an intended fine pattern can be manufactured.

Next, heat or light is irradiated onto the insulative paste to cure the insulative paste, thereby forming an insulating layer 120 (S140).

By doing so, the insulating layer 120 may be formed on both edges of the lower transparent electrode 110 and on the exposed upper regions of the substrate 100. As the spacing between the lower transparent electrodes 110 is decreased, the insulating layer pattern 120 also becomes fine. That is, the horizontal width of the insulating layer 120 is narrowed. Therefore, in the present exemplary embodiment, the fine insulating layer 120 pattern can be manufactured by printing the insulative paste including the insulative solid particles and the organic insulating layer through the printing method. Also, the processibility can be enhanced by preventing the reflow phenomenon of the insulative paste.

Also, as described in the present exemplary embodiment, only the printing apparatus, a heater or light irradiating apparatus, and a cleaning apparatus are used for forming the insulating layer 120 on both edges of the patterned transparent electrode 110, so that the production facility can be simplified.

As described above, after the lower transparent electrode 110 is formed and the insulating layer 120 is formed on both edge regions of the lower transparent electrode 110, an organic light emitting layer 130 is formed on the exposed lower transparent electrode 110.

The organic light emitting layer 130 may be formed by sequentially forming a hole injection layer (HIL) 131, a hole transport layer (HTL) 132, an emitting layer (EML) 133, an electron transport layer (ETL) 134 and an electron injection layer (EIL) 135 on the exposed lower transparent electrode 110.

The HIL 131 is formed on the lower transparent electrode 110 by forming an organic layer of CuPc or MTDATA. The HTL 132 is formed on the HIL 131 by forming an organic layer of NPB or TPD. The EML 133 is formed on the HTL 132. At this time, the EML 133 may be any one of a green EML made of Alq₃ or Alq₃:C545T, a red EML made of Alq₃:DCJTB, a blue EML made of SAlq or DPVBi, and combinations thereof. The ETL 134 is formed on the EML 133 by forming a material layer of Alq₃ or the like. The EIL 135 is formed on the ETL by forming a material layer of LiF, BCP:Cs, or the like. It is effective to form the organic light emitting layer 130 through the above processes.

Thereafter, an upper electrode 140 is formed on the organic light emitting layer 130.

That is, the upper electrode 140 is formed by depositing a metallic material on the organic light emitting layer 130 through a sputtering process. It may be effective that the metallic material is one selected from the group consisting of Al, Ag, Cu, and alloys thereof. Of course, the present invention is not limited thereto. For example, the upper electrode 140 may be made of a transparent electrode.

Of course, the technique of the present invention, i.e., the technique in which the insulating layer is formed by a printing process using a paste (i.e., ink) containing solid particles so as to prevent a shortage or opening between electrodes is not limited to the foregoing organic light emitting device, but may be applied to various electro-optical devices. That is, the technique may have various applications according to an electro-optical device layer (i.e., organic light emitting layer, light converting layer) formed on the transparent electrode layer. For example, the technique of the present invention may be applied to various electro-optical devices such as an optical sensor, a solar cell or a light emitting diode.

As set forth above, in accordance with the exemplary embodiments, the reflow phenomenon of a paste can be prevented by adding solid particles to liquid phase (i.e., gel) insulative organic material having a viscosity to prepare the paste and patterning the paste through a printing.

Also, since the present invention can prevent the reflow phenomenon, an initial shape of a pattern as printed can be maintained and thus a fine insulating pattern can be manufactured.

Although the insulative paste and the method for manufacturing an organic light emitting device using the same have been described with reference to the specific exemplary embodiments, they are not limited thereto. Therefore, it will be readily understood by those skilled in the art that various modifications and changes can be made thereto without departing from the spirit and scope of the present invention defined by the appended claims.

What is claimed is:

1. An insulative paste adapted to form an insulating layer in an electro-optical device by printing, the insulative paste comprising:
a liquid phase organic insulating material having a viscosity; and
a solid particle included in the liquid phase organic insulating material,
wherein the solid particle has a positive curvature with respect to a horizontal plane of the insulating layer.

2. The insulative paste of claim 1, wherein the insulative paste comprises 30 wt % to 85 wt % of the solid particle and 15 wt % to 70 wt % of the organic insulating material.

3. The insulative paste of claim 2, wherein the solid particle has a maximum diameter ranging from 10 nm to 15 μm.

4. The insulative paste of claim 2, wherein the solid particle has a circular, elliptical, or polygonal cross-section.

5. The insulative paste of claim 2, wherein the solid particle has a concave groove on a surface thereof.

6. The insulative paste of claim 2, wherein the organic insulating material comprises 30 wt % to 85 wt % of an organic solvent and 15 wt % to 70 wt % of an insulative polymer material.

7. The insulative paste of claim 1, wherein the insulating layer has area dimensions substantially similar to area dimensions of a pattern in which the insulative paste is printed.

8. An insulative paste, comprising:
30 wt % to 85 wt % of solid particles; and
15 wt % to 70 wt % of a liquid phase organic insulating material,
wherein the insulative paste is adapted to form an insulating layer in an electro-optical device by printing.

9. The insulative paste of claim 8, wherein the solid particle has a maximum diameter ranging from 10 nm to 15 μm.

10. The insulative paste of claim 8, wherein the solid particle has a circular, elliptical, or polygonal cross-section.

11. The insulative paste of claim 8, wherein the solid particle has a concave groove on a surface thereof.

12. The insulative paste of claim 8, wherein the insulating layer has area dimensions substantially similar to area dimensions of a pattern in which the insulative paste is printed.

13. The insulative paste of claim 8, wherein the organic insulating material comprises 30 wt % to 85 wt % of an organic solvent and 15 wt % to 70 wt % of an insulative polymer material.

14. A method for manufacturing an organic light emitting device, the method comprising:
forming a transparent electrode on a substrate;
printing an insulative paste on at least an edge region of the transparent electrode, the insulative paste including an insulative organic material and a solid particle;
curing the insulative paste to form an insulating layer; and
forming an organic light emitting layer on the transparent electrode exposed by the insulating layer.

15. The method of claim 14, wherein printing the insulative paste further comprises:
preparing the insulative paste by mixing the insulative organic material and the solid particle; and
printing the insulative paste on the substrate.

16. The method of claim 14, wherein the solid particle has a positive curvature with respect to a horizontal plane of the insulating layer and has a maximum diameter ranging from 10 nm to 15 μm.

17. The method of claim 16, wherein the solid particle has a circular, elliptical, or polygonal cross-section.

18. The method of claim 14, wherein the insulative paste is printed in a pattern on a periphery of the transparent electrode and a portion of the substrate adjacent to the periphery of the transparent electrode, the pattern exposing a central region of the transparent electrode.

19. The method of claim 18, wherein the insulating layer has area dimensions substantially similar to area dimensions of the pattern.

20. The method of claim 14, wherein the insulative organic material comprises 30 wt % to 85 wt % of an organic solvent and 15 wt % to 70 wt % of an insulative polymer material.
